(19) United States
(12) Patent Application Publication
(10) Pub. No.: US 2009/0102179 A1
(43) Pub. Date: Apr. 23, 2009

(54) COUNTERFEIT PROOF LABELS HAVING AN OPTICALLY CONCEALED PROGRESSIVE SHIFTING SECURITY SAFETY SYMBOL FOR QUICK VISUAL IDENTIFICATION UTILIZING A MOBILE PHONE FOR ONLINE VERIFICATION

(76) Inventor: Allen K. Lo, Hong Kong (HK)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/877,091

(22) Filed: Oct. 23, 2007

(51) Int. Cl. B42D 15/00

(52) U.S. Cl. 283/79

(57) ABSTRACT

The prevention of counterfeiting labels for various products is addressed by introducing counterfeit proof labels having an optically concealed, invisible progressive shifting security safety symbols for quick identification. The label is printed on a high-resolution micro-optic photo chromogenic material. A multiple number of images of an optically compressed security safety symbol are printed on the focal plane along the linear optical center of each micro-lenticule across the entire area or a small portion of the label. Due to the optical effect of the micro-optic, the complete security safety symbol is not clearly visible at normal viewing distance. When viewing the label directly or using the camera of a mobile phone at a close-up distance or slightly bending the label, each micro-lenticule within the viewing angle projects and magnifies a small section of the compressed security safety symbol on the surface of the micro-lenticules to reassemble the complete original image of the security safety symbol for identification.

The image elements that compose the compressed security safety symbols under each micro-lenticules are printed at the approximately same location on the focal plane of each micro-lenticule in relation to the linear optical center of the micro-lenticule. Therefore the same and complete reassembled image of the security safety symbol can be seen from any location of the label for quick identification. The complete reassembled image of the security safety symbol is progressive shifting following a moving viewpoint for quick and accurate identification.

The color photo of the reassembled security safety symbol can be sent by a mobile phone installed with a related software to an Anti-Counterfeiting Control Center for computer matching and verification and the consumer will be advised of the result in a matter of seconds

### FIELD OF INVENTION

The present invention relates to an anti-counterfeiting label having an optical compressed security safety symbol repeatedly printed under a plurality of micro-lenticules of the label and specifically the invention is based on the use of a high-resolution micro-optic photographic material.

The image elements of the plurality compressed security safety symbols under each micro-lenticule are printed at approximately the same location on the focal plane of each micro-lenticule in relation to the linear optical center of the micro-lenticules. Therefore the same and complete reassembled security safety symbol can be seen from any location of the label for quick identification, the reassembled security safety symbol progressively shifts following a moving viewpoint. When using the camera of a mobile phone a complete security safety symbol is always displayed in the center of the screen of the mobile phone for accurate identification. The photo of the security safety symbol can be sent by the mobile phone (installed with software) to an anti-counterfeiting control center for online verification.

### BACKGROUND OF THE INVENTION

Counterfeiting is an old problem, despite the advancement in technology. There is still no practicable solution to prevent counterfeiting effectively, the reason being that the general consumers cannot positively identify and verify the authenticity of a counterfeited label on the spot.

It is therefore the objective of this invention to provide an anti-counterfeiting label that can be easily and positively identified by the consumers. Another objective of this invention is to provide an anti-counterfeiting label that can be further verified by a mobile phone (with a built-in digital camera and installed with a related software) online by sending the photo of the security safety symbol to an Anti-Counterfeiting Control Center (to be set up) for verification. Another additional objective of this invention is to provide an anti-counterfeiting label that can be read under visible light source by human eyes for immediate identification without special viewing aids. A further objective of this invention is to provide an anti-counterfeiting label that can be verified with a reference card printed with a reference security safety symbol.

The reference security safety symbol can be printed in a small area of a credit card, driver license, an ID card or a reference card as a device to match and verify anti-counterfeiting label used on products.

### SUMMARY

This invention relates to counterfeit-proof labels having invisible progressive shifting symbols for quick identification. The label is printed on a high-resolution micro-optic photographic material. A multiple number of images of an optically compressed security safety symbol are printed on the focal plane along the linear optical center of each micro-lenticule across the entire area or a small portion of the label. Due to the optical effect of the micro-optic, the complete security safety symbol is not clearly visible at normal viewing distance. When viewing the label directly or using the camera of a mobile phone at a close-up distance or slightly bending the label, each micro-lenticule within the viewing angle projects and magnifies a small section of the compressed security safety symbol on the surface of the micro-lenticules to reassemble the complete original image of the security safety symbol for identification. There are many advantages of using high resolution micro-optic photographic material for the making of anti-counterfeit labels with an invisible optical effect progressive shifting security safety symbol and sending the photo of the security safety symbol by a mobile phone to an Anti-counterfeiting Control Center for verification including:

### (1) Quick Identification

By slightly bending the label, the concealed security safety symbol will reassemble on the label.

### (2) Easy Identification and Simplicity

Aiming the camera of the mobile phone at any location of the label at a close-up distance, the invisible security safety symbol will be displayed on the viewing screen, which can be matched with the revealed symbol printed on the label or product package for verification.

### (3) Online Verification

Using the mobile phone a photo of the symbol can be sent to an Anti-Counterfeiting Center (to be set up) for matching and verification.

### (4) Convenience

Easy verification of the label by using reference card with a matching security safety symbol for verifying the anti-counterfeiting label on products at any location and time.

### (5) Consumer Friendly

The anti-counterfeiting security safety features on the label are designed for consumer self-verification. No expert or special verification tools are required.

### (6) Counterfeit Proof

The security safety features are optically compressed into a great number of high resolution image elements and interlaced in groups at the focal plane of each micro-lens at a precalculated location in relation to the optical center of the lenticular screen and therefore the security safety symbol is invisible at a normal viewing distance and is very difficult to be counterfeited.

### (7) Universal

International standard security safety symbol.

### (8) Globalization

The system can be implemented into the global mobile phones network.

### (9) Many Application

The system can be designed for labels, tickets, credit cards, I.D. cards and product packaging.

### BRIEF DESCRIPTION OF THE DRAWINGS

FIG. 1. is the enlarged isometric view of a small portion of the label showing the structure of the micro-optic photographic material.

FIG. 2. is the enlarged cross-section of a small portion of the label showing the compressed image elements magnified by the micro-lenticules.

FIG. 3. is the enlarged cross-section of a small portion of the label showing different compressed image elements magnified by the micro-lenticule.

FIG. 4. is an enlarged cross-section of a small portion of the label showing the original image of a security safety symbol optically compressed in the x direction and printed on the focal plane of each micro-lenticule.

FIG. 5. is the enlarged cross-section of a small portion of the label showing when viewing the label at a close up distance or by the camera of a mobile phone, each micro-lenticule projects a different section of the compressed image of the security safety symbol to reassemble the completed security safety symbol.

FIG. 6. is the isometric view of a small portion of the label showing when viewing the label at a close-up distance, each micro-lenticule projects a different section of the compressed image of the security safety symbol and magnifies on the surface of the micro-lenticule to reassemble the complete security safety symbol of the RGB three color bar code design.

FIG. 6A. shows the progressive shifting of an image structure of the letter “G” design.

FIG. 7. is the enlarged isometric view of a small portion of the label showing a security safety symbol of a “cross” design.

FIG. 8. is the enlarged isometric view of a small portion of the label showing a security safety symbol of the letter “G” design.

FIG. 9. and FIG. 9A is the enlarged isometric view of a small portion of the label showing a multiple number of a compressed security safety symbol printed on each micro-lenticule across the label and a complete reassembled security safety symbol can be seen from any viewpoint across the label.

FIG. 10. is a front view of the label showing that when the label is viewed from a normal distance, the security safety symbol does not clearly appear on the label.

FIG. 11. is the front view of a label showing the consumer slightly bending the label resulting in the security safety symbol being reassembled and appear on the label.

FIG. 12. is the front view of the label showing that when viewing the label at a close-up distance, the security safety symbols appears on the label.

FIG. 13. is a front view of a label and a mobile phone showing the camera of a mobile phone aimed at the label, with the camera lens reassembling the security safety symbol and displaying it on the screen.

FIG. 14. illustrates a reference card is partially overlapping a label showing the consumer slightly bending both the reference card and the label, with the security safety symbol of the label matched with the security safety symbol of the reference card.

FIG. 15. illustrates a reference card partially overlapping a label showing the consumer slightly bending both the reference card and the label, with the security safety symbols of the label mismatched with the security safety symbol of the reference card.

FIG. 16. illustrates a reference card partially overlapping a label showing the consumer aiming the camera of a mobile phone at the overlapping area, with the security safety symbols of the label matched with the security safety symbol of the reference card and displayed on the screen of the mobile phone.

FIG. 17. illustrates a reference card partially overlapping a label showing the consumer aiming the camera of a mobile phone at the overlapping area with the security safety symbols of the label mismatched with the security safety symbol of the reference card and displayed on the screen of the mobile phone.

FIG. 18. is the enlarged isometric view of a small portion of a reference card partially overlapping a label showing that the same image element of the compressed security safety symbol of the reference card and the label are printed at the same location on the focal plane perpendicular to the linear optical center of the lenticule and therefore the same image element of the security safety symbol of the reference card and the label are magnified on the surface of the lenticules.

FIG. 18A is the enlarged cross section of a small portion of a reference card overlapping a label showing that both image elements 6a of reference card the label are perpendicular to optical center of the lenticules.

FIG. 19. is the enlarged isometric view of a small portion of a reference card partially overlapping a label showing a different image element of the compressed security symbol of the label is printed at the same location on the focal plane perpendicular to the linear optical center of the lenticule so that the magnified image element of the security safety symbol of the label is not matched with the magnified image element of the security safety symbol of the reference card.

FIG. 19A is the enlarged cross-section of a small portion of a reference card overlapping a label showing that image element 6a of the reference card is perpendicular to the optical center of the micro-lenticule.

FIG. 19B is the enlarged cross-section of a small portion of a reference card overlapping a label showing the image of the color bar printed on the wrong position of the micro-lenticule so that the magnified color bar is not aligned with the color bar of the reference card.

FIG. 20. is a schematic view of a label printing system showing the width of the compressed image element is controlled by the width of the aperture of the projecting lens.

FIG. 21. is the enlarged top view of a small portion of a label with a section of the micro-lenticule layer being omitted, showing multiple number of the compressed security safety symbol of the letter ‘G’ printed on the focal plane within each micro-lenticule and a reassembled security safety symbol of the letter ‘G’ is magnified on the surface of the lenticules 2a, 2b, 2c, 2d and 2e, with 6a, 6b, 6c, 6d and 6e being different sections of the compressed security safety symbol of a letter G.

FIG. 22. is the enlarged top view of a small portion of a label with the micro-lenticule layer being omitted showing more than one design of security safety symbol printed on the same label.

FIG. 23. Illustrates the enlarged top view of a small portion of the label with the micro-lenticule layer being omitted showing the compressed image of a linear design security safety symbol composed of many different colored bars.

### DETAILED DESCRIPTIONS OF THE DRAWINGS

An exemplary embodiment of the invention will be described in conjunction with the drawings in which:

FIG. 1. is the enlarged isometric view of a small portion of the label showing the structure of the micro-optic photographic material, in which

the numeral 1 is the enlarged isometric view of a small portion of the label
the numeral 2 is an individual micro-lenticule.
the numeral 3 is the linear optical center of the micro-lenticule
the numeral 4 is the focal plane of the lenticule
the numeral 5 is the photographic layer and
the numeral 6 is the compressed image element.
The numeral 101 represents the width of the micro-lenticule,
the numeral 102 represents the thickness of the micro-optic material and
the numeral 103 is the coverage of a micro-lenticule.

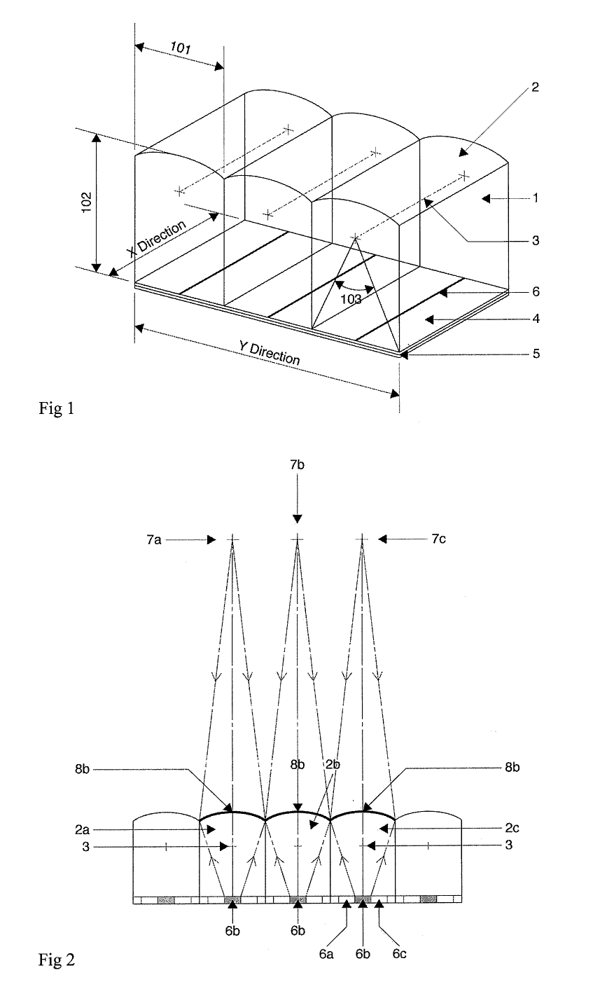

FIG. 2. is the enlarged cross-section of a small portion of the label showing the compressed image elements magnified by the micro-lenticules, in which the

numerals 2a, 2b and 2c are the individual micro-lenticules,
the numerals 6a, 6b and 6c represent a compressed image element,
the numerals 7a, 7b and 7c represent the viewing positions for viewing the image elements 6a, 6b and 6c and
the numeral 8b is the magnified image of compressed image element 6b.

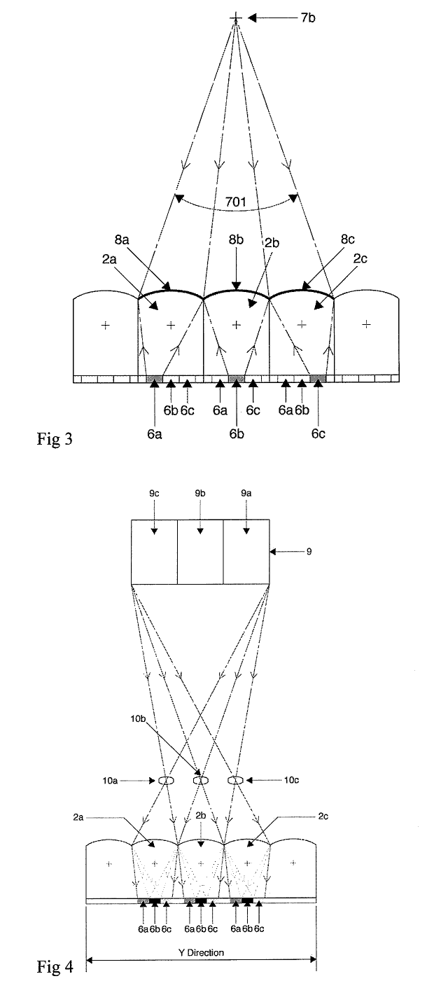

FIG. 3. is the enlarged cross-section of a small portion of the label showing different compressed image elements magnified by the micro-lenticule,

in which the numerals 2a, 2b and 2c represent individual micro-lenticules, numerals 6a, 6b and 6c represent compressed image elements printed at different locations on the focal plane of each micro-lenticule. This cross-section of the label is viewed from location 7b at a viewing angle of 701. The magnified images of the compressed image elements 6a, 6b and 6c are 8a, 8b, and 8c.

FIG. 4. is an enlarged cross-section of a small portion of the label showing the original image of a security safety symbol optically compressed in the x direction and printed on the focal plane of each micro-lenticule, in which the

numeral 9 represents the original image of a security safety symbol,
numerals 9a, 9b and 9c each represent a different section of the security safety symbol,
the numerals 10a, 10b and 10c represent the projecting lenses,
6a, 6b and 6c are the compressed image elements of the different sections 9a, 9b and 9c respectively of the security safety symbol 9.

FIG. 5. is the enlarged cross-section of a small portion of the label showing when viewing the label at a close up distance or by the camera of a mobile phone, each microlenticule projects a different section of the compressed image of the security safety symbol to reassemble the completed security safety symbol,

the numeral 9 is the reassembled security safety symbol,
the numerals 9a, 9b and 9c are the magnified image elements 6a, 6b and 6c of the compressed security safety symbol 9.

The numeral 11 represents the camera lens of the mobile phone or the eye of the viewer. The camera lens 11 has a viewing angle of 1101.

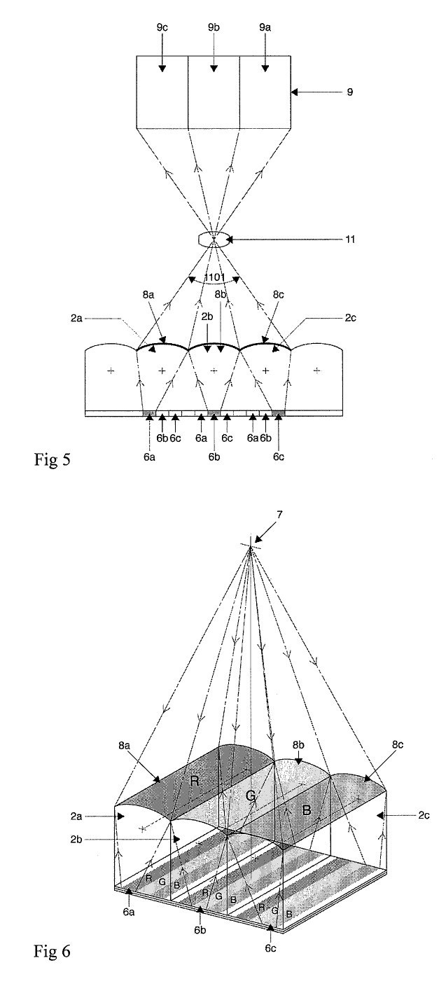

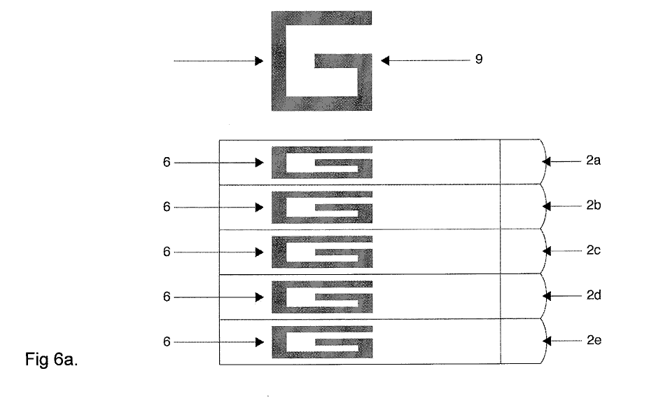

FIG. 6. is the isometric view of a small portion of the label showing when viewing the label at a close-up distance, each micro-lenticule projects a different section of the compressed security safety symbol and magnifies on the surface of the micro-lenticule to reassemble the complete security safety symbol of the RGB three color bar code design,

the numerals 6a, 6b and 6c are the sections of the compressed security safety symbol 7 is the viewing point of the label
the numerals 8a, 8b and 8c are the magnified sections of the compressed image elements of the security safety symbols 6a, 6b and 6c.

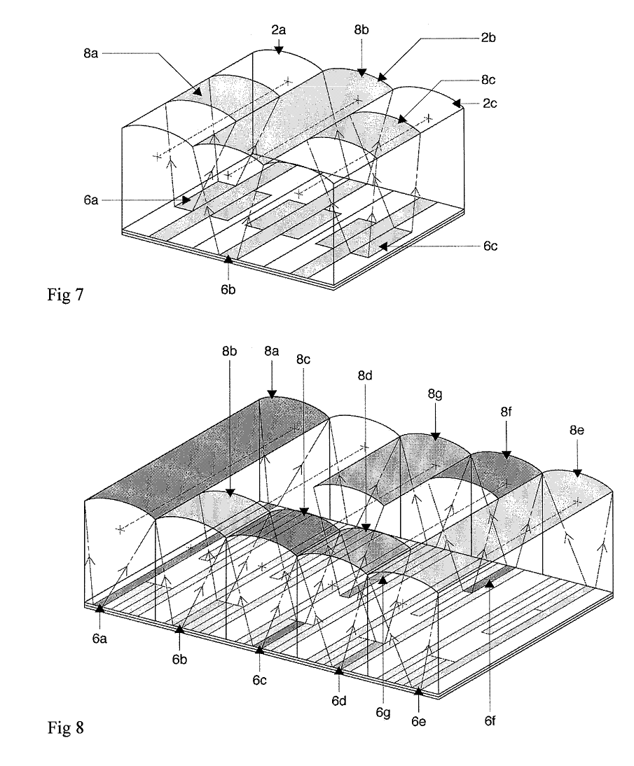

FIG. 7. is the enlarged isometric view of a small portion of the label showing a security safety symbol of a “cross” design, in which

numerals 2a, 2b and 2c represent individual lenticules and
the numerals 6a, 6b and 6c represent sections of the compressed security safety symbol, and
numerals 8a, 8b and 8c represent the magnified sections of the compressed security safety symbols 6a, 6b and 6c.

FIG. 8. is the enlarged isometric view of a small portion of the label showing a security safety symbol of the letter “G” design, in which

numerals 6a, 6b, 6c, 6d, 6e, 6f and 6g represent sections of the compressed security safety symbol “G”, and
the numerals 8a, 8b, 8c, 8d, 8e, 8f and 8g represent magnified sections of the compressed security safety symbols 6a, 6b, 6c, 6d, 6e, 6f and 6g.

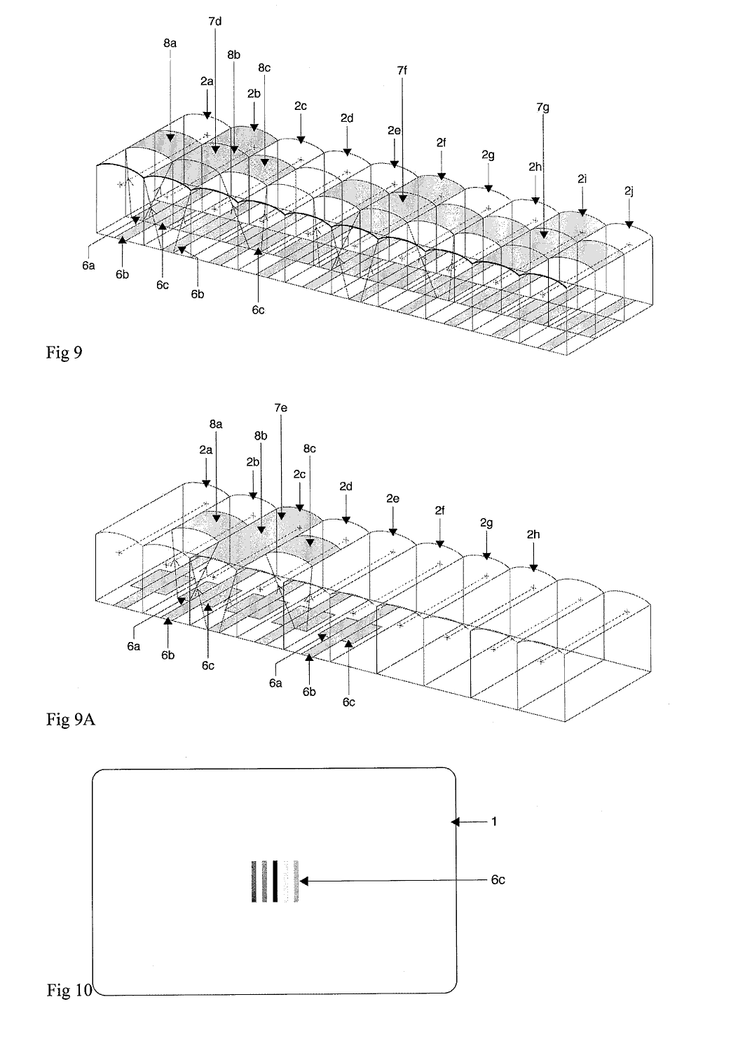

FIG. 9. and FIG. 9A is the enlarged isometric view of a small portion of the label showing a multiple number of a compressed security safety symbol printed on each micro-lenticule across the label and a complete reassembled security safety symbol can be seen from any viewpoint across the label, in which

The numerals 2a-2j are the individual lenticules,
The numerals 6a, 6b and 6c are the different sections of the compressed security safety symbol,
The numerals 7d, 7e, 7f and 7g are the different viewpoints, and
the numerals 8a, 8b and 8c are the magnified sections 6a, 6b and 6c of the compressed security safety symbol.

FIG. 10 is a front view of the label showing that when the label is viewed from a normal distance, the security safety symbol does not clearly appears on the label, in which

the numeral 1 is the label, and
The numeral 6C is the magnified scrambled image elements of the section of the compressed images of the security safety symbol.

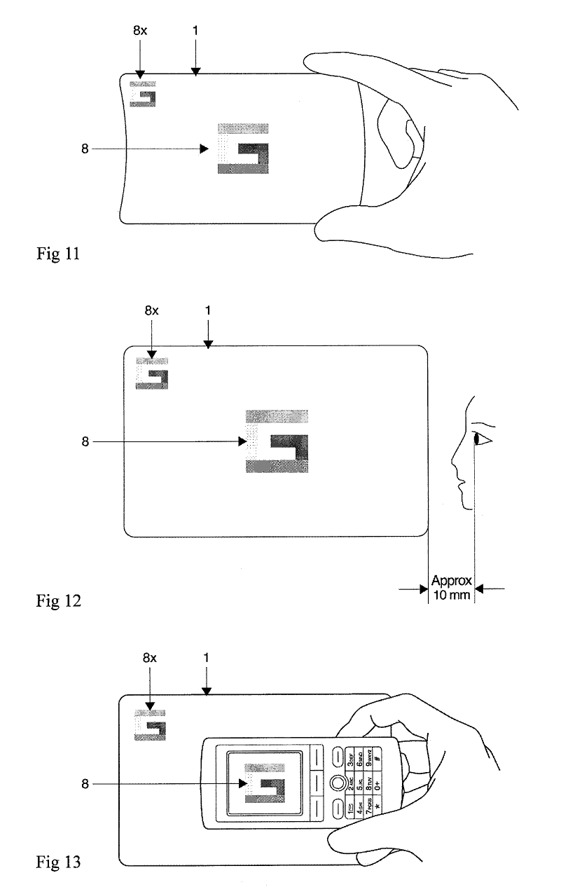

FIG. 11. is the front view of a label showing the consumer slightly bending the label, resulting in the security safety symbol being reassembled and appearing on the label, in which

the numeral 1 is the label,
the numeral 8 is the reassembled security safety symbol and
the numeral 8x is the reference symbol printed on the label for matching with the reassembled security safety symbol 8.

FIG. 12. is the front view of the label showing that when viewing the label at a close up distance, the security safety symbol appears on the label, in which

the numeral 1 is the label,
the numeral 8 is the reassembled security safety symbol, and
the numeral 8x is the reference security safety symbol printed on the label for matching with the reassembled security safety symbol 8.

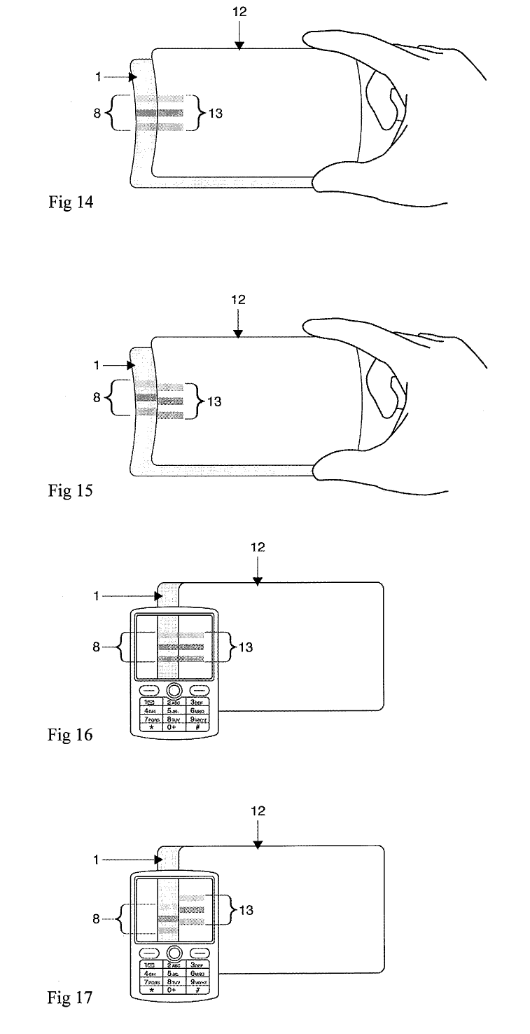

FIG. 13. is a front view of a label and a mobile phone showing the camera of a mobile phone aimed at the label, with the camera lens reassembling the security safety symbol and displaying it on the screen.

the numeral 1 is the label,
the numeral 8 is the reassembled security safety symbol, and
the numeral 8x is the reference security safety symbol printed on the label for matching with reassembled security safety symbol 8.

FIG. 14. illustrates a reference card is partially overlapping a label showing the consumer slightly bending both the reference card and the label with the security safety symbol of the label is matched with the security safety symbol of the reference card in which

the numeral 1 is the label,
the numeral 8 is the reassembled security safety symbol of the label,
the numeral 12 is the front view of a reference card, and
the numeral 13 is the reassembled security safety symbol of the reference card.

FIG. 15. illustrates a reference card is partially overlapping a label showing the consumer slightly bending both the reference card and the label with the security safety symbols of the label mismatched with the security safety symbol of the reference card in which

the numeral 1 is the label,
the numeral 8 is the reassembled security safety symbol of the label,
the numeral 12 is the front view of a reference card and
the numeral 13 is the reassembled security safety symbol of the reference card.

FIG. 16. illustrates a reference card partially overlapping a label showing the consumer aiming the camera of a mobile phone at the overlapping area, with the security safety symbols of the label matched with the security safety symbol of the reference card and displayed on the screen of the mobile phone, in which

the numeral 1 is the label,
the numeral 8 is the reassembled security safety symbol of the label,
the numeral 12 is the front view of a reference card and
the numeral 13 is the reassembled security safety symbol of the reference card.

FIG. 17. illustrates a reference card partially overlapping a label showing the consumer aiming the camera of a mobile phone at the overlapping area and with the security safety symbols of the label mismatched with the security safety symbol of the reference card and display on the screen of the mobile phone, in which

the numeral 1 is the label,
the numeral 8 is the reassembled security safety symbol of the label,
the numeral 12 is the front view of a reference card, and
the numeral 13 is the reassembled security safety symbol of the reference card.

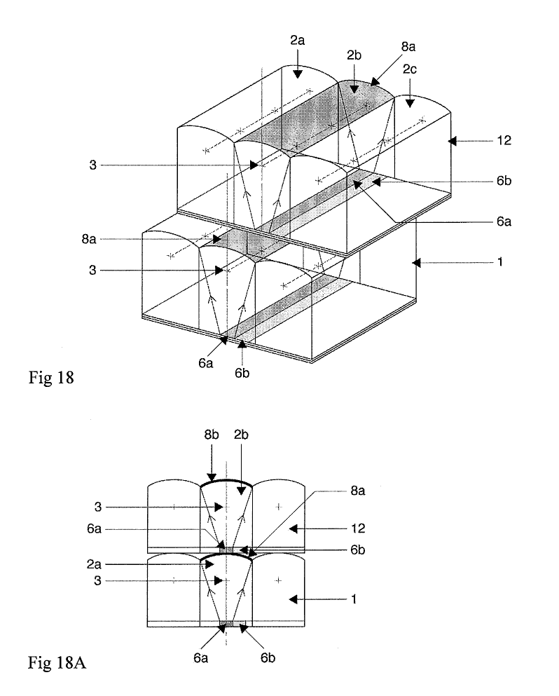

FIG. 18. is the enlarged isometric view of a small portion of a reference card partially overlapping a label showing that the same image element of the compressed security safety symbol of the reference card and the label are printed at the same location on the focal plane perpendicular to the linear optical center of the lenticule and therefore the same image element of the security safety symbol of the reference card and the label are magnified on the surface of the lenticules, in which

the numeral 1 is the label
the numerals 6a and 6b are different sections of the compressed security safety symbol of the label,
the numeral 8a is the magnified image 6a of the compressed security safety symbol of the reference card and the label, and
the numeral 12 is the reference card.

FIG. 18A is the enlarged cross section of a small portion of a reference card overlapping a label showing that both image elements 6a of reference card the label are perpendicular to optical center of the lenticule, in which

the numeral 1 is the label,
the numeral 2b is a micro-lenticule,
the numerals 6a and 6b are the different sections of the compressed security safety symbol,
the numeral 8a is the magnified image of 6a, and
the numeral 12 is the reference card.

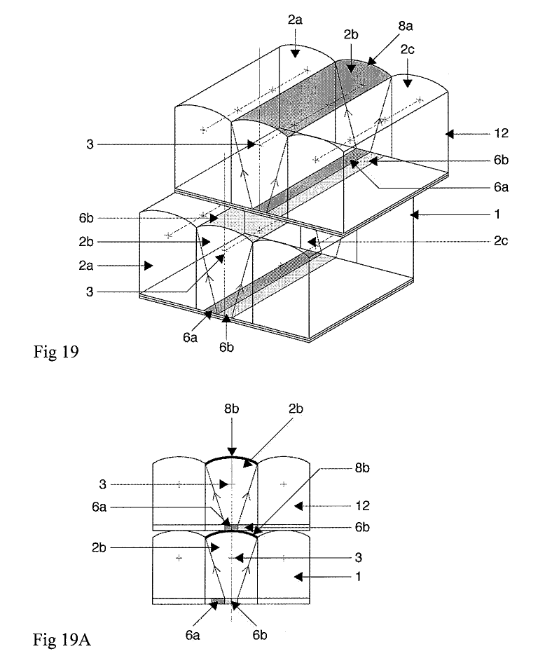

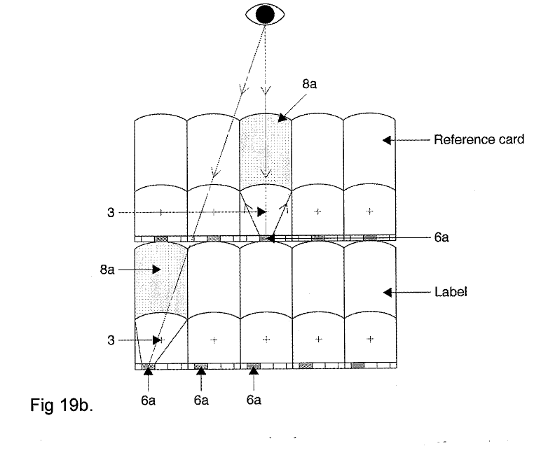

FIG. 19. is the enlarged isometric view of a small portion of a reference card partially overlapping a label showing that a different image element of the compressed security symbol of the label is printed at the same location on the focal plane perpendicular to the linear optical center of the lenticule so the magnified image element of the security safety symbol of the label is not matched with the magnified image element of the security safety symbol of the reference card in which

the numeral 1 is the label,
the numerals 6a and 6b are the different sections of the compressed security safety symbol of the label,
the numerals 8a and 8b are the magnified images of 6a and 6b of the compressed security safety symbol of the reference card and the label, and
the numeral 12 is the reference card.

FIG. 19A is the cross-section of a small portion of a reference card overlapping a label showing that image element 6a of the reference card is perpendicular to the optical center of the micro-lenticule, in which

the compressed security safety symbol of the label is misprinted and image element 6b is perpendicular to the optic center of the micro-lenticule in which
the numeral 1 is the label,
the numeral 2b is a micro-lenticule,
the numerals 6a and 6b are the different sections of the compressed security safety symbol,
the numerals 8a and 8b are the magnified image element of 6a and 6b, and 12 is the reference card.

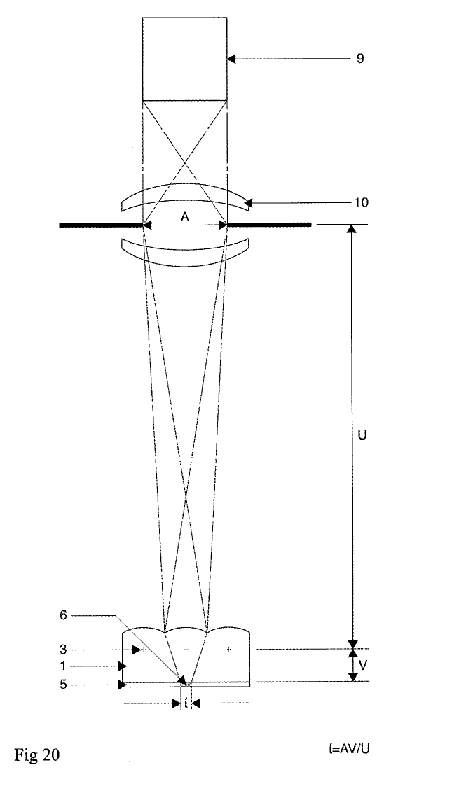

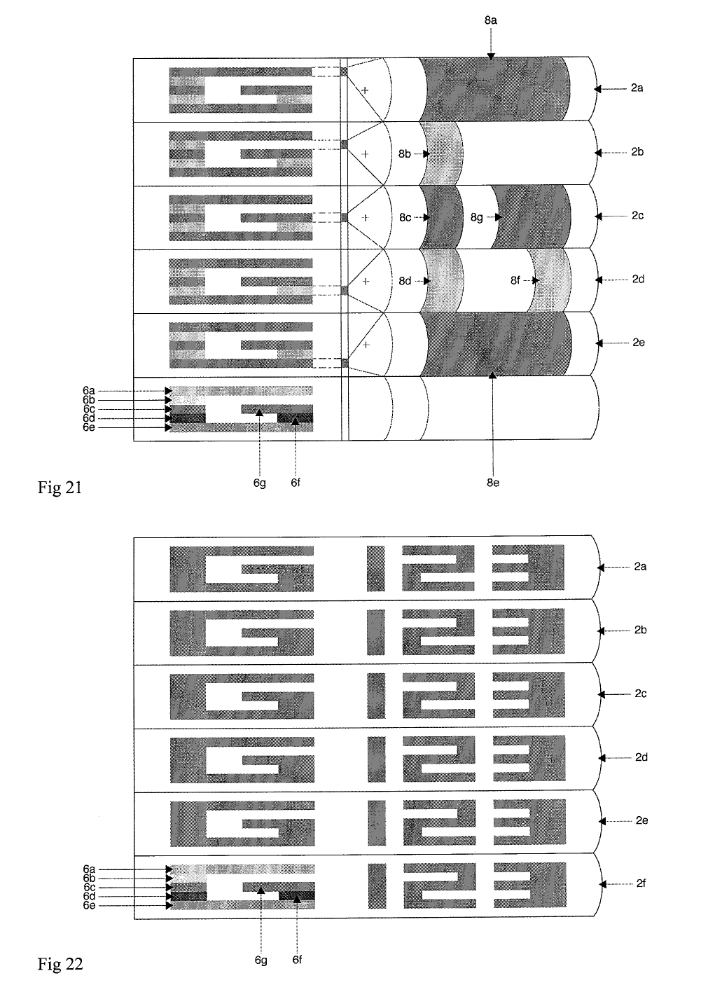

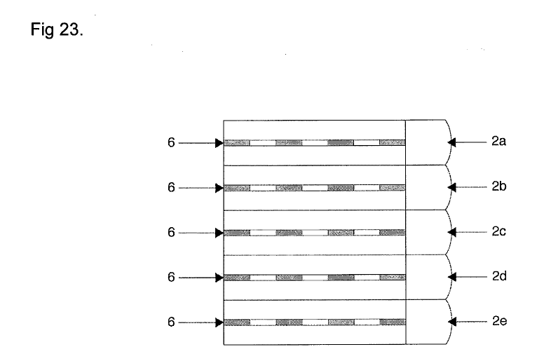

FIG. 20. is a schematic view of a label printing system showing the width of the compressed image element is controlled by the width of the aperture of the projecting lens, in which

the numeral 1 is the label,
the numeral 3 is the linear optical center of the micro-lenticule,
the numeral 5 is the focal plane of the micro-lenticule,
the numeral 6 is the compressed image element of the security safety symbol,
the numeral 9 is the original image of the security safety symbol,
the numeral 10 is the projecting lens,
A is the aperture of the projecting lens,
ι is the width of the compressed image element,
U is the distance between A and 3 and
V is the distance between 3 and 5.

FIG. 21. is the enlarged top view of a small portion of a label with a section of the micro-lenticule layer being omitted, showing a multiple number of compressed security safety symbol of the letter ‘G’ printed on the focal plane within each micro-lenticule and a reassembled security safety symbol of the letter ‘G’ is magnified on the surface of the lenticules 2a, 2b, 2c, 2d and 2e with 6a, 6b, 6c, 6d and 6e being different sections of the compressed security safety symbol of a letter “G”, in which

the numerals 8a, 8b, 8c, 8d and 8e are the magnified images of 6a, 6b, 6c, 6d and 6e that reassemble the original security safety symbol ‘G’ and
the numerals 2a, 2b, 2c, 2d and 2e are the micro-lenticules.

FIG. 22. is the enlarged top view of a small portion of a label with the micro-lenticule layer being omitted showing more than one design of security safety symbol are printed on the same label, in which

the numerals 6a, 6b, 6c, 6d and 6e are the different section of the compressed security safety symbol of the letter G, and
the numerals 2a, 2b, 2c, 2d and 2e are the micro-lenticules.

### DETAILED DESCRIPTION OF THE INVENTION

According to the present invention, the anti-counterfeiting label is produced on a high-resolution micro-optic photographic material.

The image of the security safety symbol of the label is optically compressed only in the Y direction across the semi-cylindrical curvature of the micro-lenticule (the width of the compressed security safety symbol is equal to or smaller than the aperture of the micro-lenticule). A multiple number of the same compressed security safety symbol are printed along the linear optical center on the photographic layer on the focal plane of each micro-lenticule on a small designated area or across the entire area of the label.

Due to the optical effect of the micro-lenticules, the image of the security safety symbol printed on the focal plane of the micro-lenticules is not clearly visible on the label when viewing at a normal distance.

When viewing the label directly or with the camera of a mobile phone at a close up distance or slightly bending the label, each micro-lenticule (within the coverage of the viewing angle of a person or of a camera lens) projects and magnifies a different section of the compressed security safety symbol on the surface of the micro-lenticule to reassembles the original image of the security safety symbol. The image elements that composes each compressed security safety symbol are printed at the same location on the focal plane in relation to the linear optical center of each micro-lenticule. Therefore, the image of the reassembled security safety symbol will progressively shift following a moving viewing point across the label and the same and a complete security safety symbol can be seen from any viewpoint across the lenticules of the label for quick and accurate identification.

The photo of the security safety symbol can be sent to the anti-counterfeiting center for online verification. A reference security safety symbol can be printed on a small area of an ID card or credit card or a master reference card to match and verify the security safety symbol on the anti-counterfeiting label using the same system on location.

FIG. 1. illustrates the structure of a micro-optic anti-counterfeiting label; 1 denotes an enlarged cross section of a small portion of the label, 2 is a micro-lenticule made of a high quality polymer having a refractive index between 1.4 and 1.65, and having a width 101 between 0.01 mm and 10 mm and having a thickness 102 between 0.05 mm and 10 mm and has a coverage angle 103 between 2 degrees and 70 degrees, 3 is the linear optical center of the micro-lenticule, 4 is the focal plane of the micro-lenticule, 5 is the photographic layer or the image layer attached to the focal plane of the micro-lenticules, 6 is one of the compressed image elements of the security safety symbol.
FIG. 2. illustrates viewing the label from viewpoints 7a, 7b and 7c, from which only image elements 6b of micro-lenticules 2a, 2b and 2c (perpendicular to viewpoints 7a, 7b and 7c) can be seen.
FIG. 3. illustrates viewing the label from viewpoint 7b with a viewing angle 701, image elements 6a, 6b and 6c are respectively project by micro-lenticule, 2a, 2b and 2c. 8a, 8b and 8c are the magnified image elements of 6a, 6b and 6c.
FIG. 4. illustrates the original image of the security safety symbol 9 optically projected by projection lenses 10a, 10b and 10c and compressed in the Y direction and printed on the focal plane of micro-lenticules 2a, 2b and 2c, 6a, 6b and 6c are the compressed image elements of sections 9a, 9b and 9c of the security safety symbol 9.
FIG. 5. illustrates when viewing the label directly or using the camera of a mobile phone 11 at a close distance, micro-lenticules 2a, 2b and 2c each of which project a different section 6a, 6b and 6c of the compressed security safety symbol to reassemble the original security safety symbol 9, 9a, 9b and 9c are different sections of the security safety symbol. 8a, 8b and 8c are the magnified image elements of 6a, 6b and 6c.
FIG. 6. illustrates micro-lenticules 2a, 2b and 2c, each of which projects and magnifies a different section 6a, 6b and 6c of the compressed security safety symbol to reassemble the original security safety symbol composed by magnified images 8a, 8b and 8c. The compressed security symbol composed by sections 6a, 6b and 6c can be produced by a photographic process, lithographic printing process, transfer, hot stamp, embossing, laser etching, holographic, laminating and any other imaging or reproduction method.
FIG. 7. illustrates micro-lenticules 2a, 2b and 2c each of which projects and magnifies a different section 6a, 6b and 6c of the compressed security safety symbol to reassemble the original security safety symbol composed by magnified images 8a, 8b and 8c.
FIG. 8. illustrates a security safety symbol of the letter ‘G’ design, which is reassembled by magnified images 8a to 8g from compressed image elements 6a to 6g.
FIG. 9. & FIG. 9A. illustrates a multiple number of a compressed security safety symbols which is composed of image elements 6a, 6b and 6c printed in the approximate location on the focal plane of micro-lenticules 9a-9j across the label.
   From viewpoint 7d compressed image element 6a under micro-lenticule 2a forms magnified image 8a on the same micro-lenticule 2a.
   Compressed image element 6b under micro-lenticule 2b forms magnified image 8b on the same micro-lenticule 2b and compressed image element 6c under micro-lenticule 2c forms magnified image 8c on the same micro-lenticule 2c to reassemble the original security safety symbol.
   The complete reassembled security safety symbol can be seen at any viewpoint perpendicular to any micro-lenticule including viewpoints 7d, 7e, 7f and 7g.
   The reassembled security safety symbol is progressive shifting following a moving point across the label.
FIG. 10. illustrates when viewing the label at normal distance and due to the viewing angle, the group of micro-lenticules do not project the correct sections of the compressed security safety symbol and therefore the magnified image cannot reassemble the original security safety symbol.
FIG. 11. illustrates when the label is slightly bent the group of micro-lenticules project the correct sections of the compressed security safety symbol and reassemble them on the surface of the label.
FIG. 12. illustrates when the label is viewed at a close-up distance, the group of micro-lenticule, project the correct sections of the compressed security symbol and reassemble them on the surface of the label.
FIG. 13. illustrates when the label is viewed by the camera of a mobile phone, the group of micro-lenticule project the correct sections of the compressed security safety symbol and reassemble the original image of the security safety symbol 8 in the center of the screen.
   The consumer can match the reassembled security safety symbol 8 with the reference symbol 8x printed at a corner of the label for verification.
FIG. 14. illustrates a reference card 12 partially overlapping a label 1. By slightly bending the card 12 and the label 1 the reassembled security safety symbol 13 on the reference card is matched with the reassembled symbol 8 on the label, verifying that the label is authentic.
FIG. 15. illustrates the reassembled security safety symbol 8 on the label 1 which does not match with the reassembled symbol 13 on the reference card 12, proving that the label is counterfeit.
FIG. 16. illustrates the camera of a mobile phone which is aimed at the overlapping area of a reference card 12 and a label 1, the reassemble security safety symbol 8 is matched with the reassembled symbol 13 on the reference card and display in the center of the screen proving that the label is authentic.
FIG. 17. illustrates the reassembled security safety symbol 8 on the label 1 which is not matched with the reassembled symbol 13 of the reference card, proving that the label is counterfeit.
FIG. 18. & FIG. 18A. illustrates image element 6a of the compressed printed security where the safety symbol of the micro-lenticule 2b of the label 1 and the reference card 12 are perpendicular to the linear optical center 3 of the micro-lenticules. Therefore magnified image 8a of label 1 is matched with magnified image 8a of the reference card 12 proving that the label is authentic.
FIG. 19. & FIG. 19A. illustrates where the compressed security safety symbol under micro-lenticule 2b of label 1 is printed at a wrong location. Therefore image element 6a is not perpendicular to the linear optical center 3 of the micro-lenticule 2b (instead image element of 6b is perpendicular to the linear optical center 3 of the lenticule) and magnified image 8b on lenticule 2b of label 1 does not match the magnified image 6a on lenticule 2b of the reference card proving that the label is counterfeit.
FIG. 20. illustrates the width “ι” (ι=AV/U) of compressed image element 6 is controlled by the aperture A of projecting lens 10, U is the distance from the aperture A to the optical center 3 of the lenticule, V is the distance between the optical center 3 to focal plane 5 of the micro-lenticule.
FIG. 21. illustrates the enlarged top view of a small portion of a label with a section of the micro-lenticule layer being omitted, showing a multiple number of compressed security safety symbol of the letter ‘G’ printed on the focal plane within each micro-lenticule and a reassembled security safety symbol of the letter ‘G’ is magnified on the surface of the lenticules 2a, 2b, 2c, 2d and 2e with 6a, 6b, 6c, 6d and 6e having the different sections of the compressed security safety symbol of the letter G in which
   8a, 8b, 8c, 8d and 8e are the magnified images of 6a, 6b, 6c, 6d and 6e that reassemble the original security safety symbol ‘G’ and
   2a, 2b, 2c, 2d and 2e are the micro-lenticules.
FIG. 22. illustrates the enlarged top view of a small portion of a label with the micro-lenticule layer being omitted showing more than one design of security safety symbol are printed on the same label in which
   6a, 6b, 6c, 6d and 6e are the different section of the compressed security safety symbol of the letter G
   2a, 2b, 2c, 2d and 2e are the micro-lenticules.

The image of the color bar on the reference card and on the label must be printed exactly on the same location of the focal plane of each lenticule (i.e. at zero degree perpendicular to the linear optical center of the lenticules) so that the 2 color bars will match when the cards are bent or viewed with the camera of a mobile phone. If the image of the color bar on the label is printed at a wrong location (i.e. 2 degrees off the optical center of the lenticule) it will not match when viewing at a close up distance or by the camera lens of a mobile phone or digital camera. The group of micro-lenticule covered by the viewing angle of the camera lens each will project a different small section of the compressed image of the symbol to reassemble a complete symbol and magnifies it on the surface of the group of the lenticule.

Each compressed symbol is printed approximately at the same location on the focal plane of the lenticule (related to the linear optical center of the lenticules) so that at any location across the lenticules of the label a complete reassemble symbol will be seen. The reassembled symbol is progressive shifting following a moving viewpoint for quick and accurate identification with the color bar of the reference card.

Therefore, having thus described the invention, at lease the following is claimed:

1. A micro-optic anti-counterfeiting label having a concealed progressive shifting security safety symbol for quick and accurate verification wherein
the security safety symbol of the label is compressed (only in the direction across the curvature of the semi-cylindrical micro-lenticule) and is duplicated in multiple number and printed on the focal plane along the linear optical center of each micro-lenticule of the label, so that
due to the optical effect of the micro-optics, from a normal viewing distance a complete security safety symbol is not clearly visible on the surface of the label, but when viewing the label at a close up distance directly or using the camera of a mobile phone or slightly bending the label, the micro-lenticules covered within the viewing angle each projects a different small section of the compressed security safety symbol and magnified the image on the surface of the lenticule to reassemble the complete security safety symbol on the label,
wherein each micro-lenticule of the label contains the complete image of a compressed security safety symbol so that from any viewing position, a complete reassembled security safety symbol can be seen and the image of the reassembled security safety symbol of the label will shift progressively along a moving viewpoint to assure quick and accurate verification.

2. The micro-optic anti-counterfeiting label of claim 1, in which the security safety symbol is printed in a small area or the entire area of the label.

3. The micro-optic anti-counterfeiting label of claim 1, in which the label is printed with one or more security safety symbol.

4. The micro-optic anti-counterfeiting label of claim 1, in which the micro-lenticule carries one or more compressed security safety symbols.

5. The micro-optic anti-counterfeiting label of claim 1, in which the images of the security safety symbol are compressed in one direction across the curvature of the semi-cylindrical micro-lenticule.

6. The micro-optic anti-counterfeiting label of claim 1, in which the image elements of the compressed security safety symbol is printed along the linear optical center the micro-lenticules.

7. The micro-optic anti-counterfeiting label of claim 1, in which the security safety symbol can be composed of any color.

8. The micro-optic anti-counterfeiting label of claim 1, in which the security safety symbol can be designed in any format, graphic, letters or number.

9. The micro-optic anti-counterfeiting label of claim 1, in which a reference revealing matching symbol can be printed on the same label or a separate label or on the package of the product for verification and matching with the reassembled security safety symbol.

10. The micro-optic anti-counterfeiting label of claim 1, in which the images of the compressed security safety symbol are printed by a photographic process.

11. The micro-optic anti-counterfeiting label of claim 1, in which the images of the compressed security safety symbol are printed by a lithographic process.

12. The micro-optic anti-counterfeiting label of claim 1, are printed by any printing, embossing, transfer, laminating, laser etching, chemical etching, holographic or any photographic and image reproduction process.

13. A method in which the micro-optic anti-counterfeiting label of claim 1, in which the photo of the reassembled security safety symbol is sent by a mobile phone to an anti-counterfeiting control center for verification.

14. The micro-optic anti-counterfeiting label of claim 1, in which the label is produced on a high resolution micro-optic material having a refractive index between 1.4 and 1.65 and has a thickness between 0.05 mm and 10 mm and has a frequency from 0.1 to 50 lenticules per mm and the lenticule has a coverage angle from 5 degrees to 70 degrees.
